(19) United States
(12) Patent Application Publication
(10) Pub. No.: US 2019/0127204 A1
(43) Pub. Date: May 2, 2019

(54) VALVED JIGGER

(71) Applicant: The Johnston Machine Company, LLC, Gilbert, AZ (US)

(72) Inventors: JOE JOHNSTON, GILBERT, AZ (US); BRANDON FEILS, GILBERT, AZ (US)

(73) Assignee: The Johnston Machine Company, LLC, Gilbert, AZ (US)

(21) Appl. No.: 15/798,811

(22) Filed: Oct. 31, 2017

(51) Int. Cl. B67D 3/00; B65D 47/30

(52) U.S. Cl. CPC B67D 3/0045; B65D 47/30; B67D 3/009

(57) ABSTRACT

A measuring device is disclosed that increases the precision of the amount of liquid, reduces spillage waste, increases speed in creating the beverage and increases productivity. The measuring device may include a vessel body, a ball, a lever, a spring, a base and a trigger. In operation, the liquid is poured into the vessel body until its level visually matches a gradation line equal to the desired volume. The user then squeezes the standard trigger by hand to release the liquid out the bottom of the vessel body. A second trigger may be pressed against a drinking glass or pitcher to release the liquid out the bottom of the vessel body and into the drinking glass or pitcher.

### FIELD

The disclosure generally relates to a liquid dispensing device, and more particularly, to a measuring device (commonly called a “jigger” in the cocktail world) with a trigger 8 actuated dump valve to reduce spillage waste, increase speed and increase productivity.

### BACKGROUND

Different combinations of liquids are typically used to create a drink or cocktail. To provide a consistent taste and/or alcoholic content, a precise amount of each of the different liquids should be added to the cocktail. To achieve precise and consistent pours, the bartender typically needs to measure the liquid in in a separate container, then pour the measured portion into the drinking glass. Such actions usually cause the bartender to spend a longer time to create the drink and also result in additional containers being used that need to be properly cleaned before creating the next drink.

However, bartenders are often very busy and need to pour the drinks quickly in order to satisfy demanding patrons. When pouring drinks quickly, the bartender may not have time to precisely measure each liquid, and instead, the bartender may simply include a splash of different liquids based on experience without any measurement at all. Such quick and imprecise actions by the bartender, along with improper pouring techniques, excess motions to grab bottles and lack of attention, often result in spilling expensive liquids outside of the drinking glass. The spills result in a waste of product, a health hazard and a need spend time and effort cleaning the spills. As such, a long-felt need exists for a device that can quickly and precisely measure a liquid while reducing waste of the liquid.

### SUMMARY

A measuring device is disclosed that increases the precision of the amount of liquid, reduces spillage waste, increases speed in creating the beverage and increases productivity. The measuring device may include a vessel body, a ball, a lever, a spring, a base and a trigger.

The vessel body is configured to retain a liquid, wherein the vessel body includes an opening. The valve may be removably secured within the opening. The lever may be attached to a spring, wherein the lever is configured to provide a force against the valve to retain the valve within the opening, and wherein, upon rotation the lever, the force is reduced against the valve and the liquid exits the vessel body.

In operation, the liquid is poured into the vessel body until its level visually matches a gradation line equal to the desired volume. The user then squeezes the standard trigger by hand to release the liquid out the bottom of the vessel body. A second trigger may be pressed against a drinking glass or pitcher to release the liquid out the bottom of the vessel body and into the drinking glass or pitcher.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 is an exploded view of the measuring system, in accordance with various embodiments.

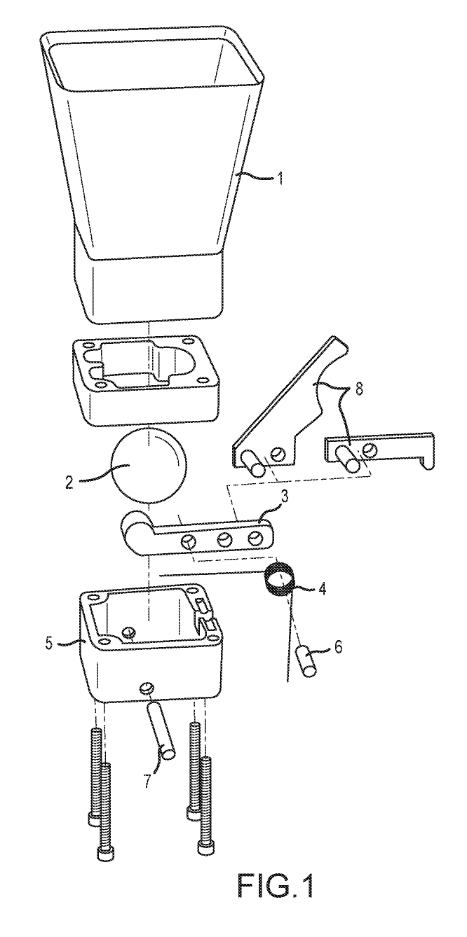

FIG. 2 is an outside view of the constructed measuring system, in accordance with various embodiments.

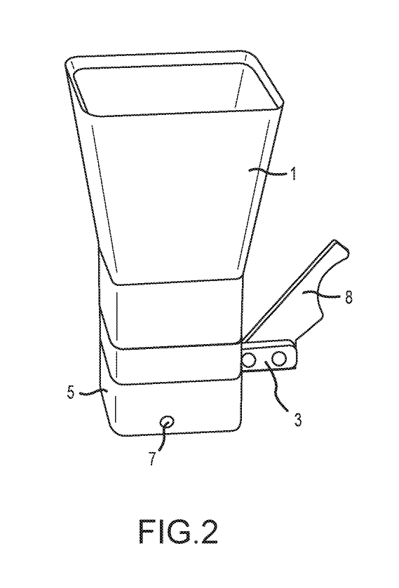

FIG. 3 is a top down view of the lever 3, spring 4 and ball 2 system with the vessel removed, in accordance with various embodiments.

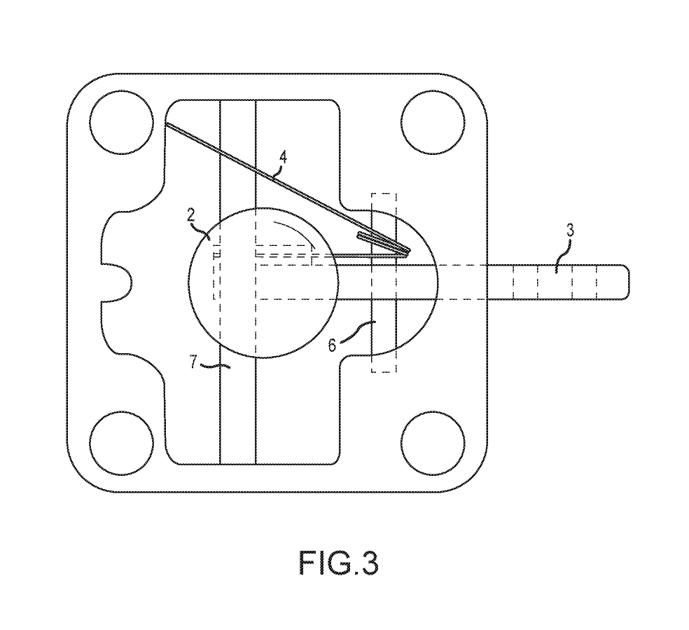

FIG. 4 is a top down view of the inside of the vessel showing the ball 2, in accordance with various embodiments.

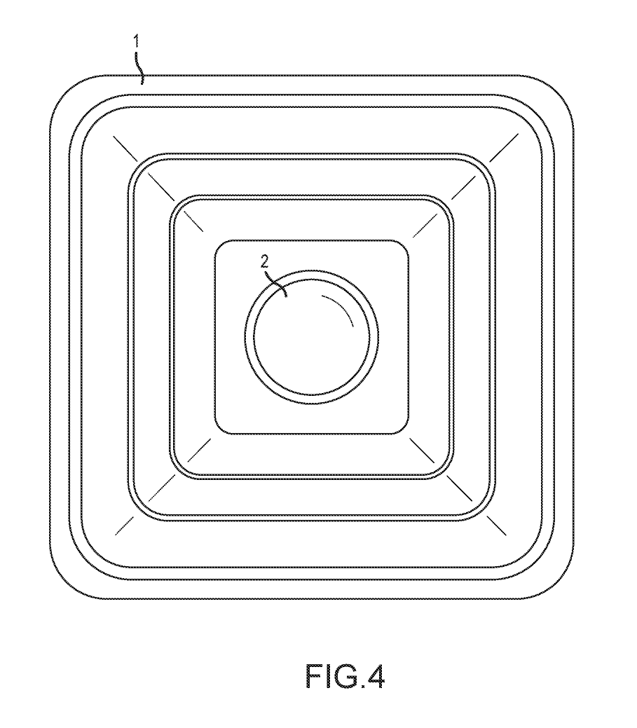

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

The disclosure includes a measuring device. The measuring device is configured to dispense a predetermined amount of liquid. The measuring device may include any component that restricts and allows liquid to flow. While the invention may be described with respect to the dispensing of a liquid, one skilled in the art will appreciate that the disclosure is similarly applicable to the dispensing of any product. For example, the measuring device may dispense a measured amount of a mixture of liquids, a paste, a powder, a crème, a gas and/or any other chemical or substance.

Some exemplary advantages of the measuring device include increasing the precision of the amount of liquid, reducing spillage waste, increasing speed in creating the beverage and increasing productivity.

In various embodiments, the system may include one or more of a vessel body 1, a ball 2, a lever 3, a spring 4, a base 5, a lever shaft 6, a spring shaft 7 and/or a trigger 8. Each of these components may be comprised of any material or composite such as, for example, metal, plastic, steel, wood, etc. The material (e.g., wood) may impart an extra flavor or taste to the liquid.

In operation, the liquid is poured into the vessel body 1. The amount of liquid in the vessel body 1 may be measured by the liquid level visually matching a gradation line equal to the desired volume. The user then squeezes (and releases) the first trigger 8 by hand to release a predetermined amount of liquid out the bottom of the vessel body 1. If the user holds the first trigger 8 for a longer period before releasing, additional liquid may be dispensed. A second trigger 8 may be used, wherein the second trigger 2 is pressed against a drinking glass or pitcher (and then released) to dispense a predetermined amount of liquid out the bottom of the vessel body 1 and into the drinking glass or pitcher. Similarly with the second trigger, if the user holds the second trigger 8 for a longer period before releasing, additional liquid may be dispensed. The amount of liquid dispensed may depend upon the strength of the spring, the size of the opening, the valve and the length of time squeezing the trigger.

In various embodiments, an electronic actuator and/or motor may interface with lever 3. In response to the user pushing a button or activating an electronic circuit, the actuator/motor may impact lever 3 and cause lever 3 to move and dispense liquid. More specifically, the actuator may react to a control signal, wherein the control signal may be electric voltage, electric current, pneumatic pressure, hydraulic pressure, or a force provided by the user. The energy source may be electric current, hydraulic fluid pressure, or pneumatic pressure. When the control signal is received, the actuator responds by converting the energy into mechanical motion to actuate lever 3 and dispense liquid. In various embodiments, the actuator/motor may be activated by a remote device via RF, infrared, Bluetooth or other communication technology. In that regard, a smartphone may be used to activate the actuator/motor (e.g., via an app on the smartphone).

In various embodiments, the vessel body 1 may be any vessel configured to retain a liquid. The vessel body 1 may be comprised of any material and be configured in any shape. For example, the vessel body 1 may be a rounded square that is tapered with a funnel shape at the bottom to direct the flow into an opening leading to the valve. The vessel body 1 may include indicators for indicating a measurement of precise liquid volumes. The graduation marks (e.g., located internally) may include steps (e.g., indentations or protrusions) at the major measurements and scribed marks (e.g., scoring of the surface) at the intermediate measurements.

The vessel body 1 may include an opening (e.g., at the bottom). The opening may include a valve. The valve may include a conical seat for a ball 2 such that the ball 2 may sit within the opening. Below the opening may lead to a channel for the liquid to flow around the ball 2. The walls of the channel may include ribs to loosely hold the ball 2 in position as the ball 2 travels up and down. In various embodiments, the valve may include a rotary valve or cylinder valve. In various embodiments, the valve may include a flap valve.

In various embodiments, the valve 2 (e.g., ball) may be any device that impedes the flow of any portion of the liquid and that may be displaced or altered to allow the flow of any portion of the liquid. For example, the ball 2 may be a sphere that seals against the conical seat in the vessel body 1. The ball 2 may be held against the seat by the lever 3.

In various embodiments, the lever 3 is any device that moves the ball 2 to different positions. The lever 3 may be supported by a lever shaft 6 and may interface with the spring 4. The lever shaft 6 may form the pivot point for the lever 3. For example, the lever 3 may hold the ball 2 against the conical seat in the vessel body 1. When the ball 2 is held against the conical seat in the vessel body 1, the liquid is restricted from flowing such that the device is in the closed position. The spring 4 may impart a force against the lever 3 such that the lever may impart a force against the bottom of the ball 2 to maintain a seal. As the trigger 8 is pulled, the force against the lever is released and the lever 3 pivots to open the valve by allowing the ball 2 to drop and open a pathway for the liquid to flow.

In various embodiments, the spring 4 is any device that maintains pressure on the lever 3. The spring 4, via engagement with the lever 3, maintains pressure on the lever 3 which presses against the ball 2, when the device is in the closed position. A spring shaft 7 may hold a first end of the spring 4, the spring 4 may interface with the lever 3, and a second end of the spring 4 may interface with any other surface (e.g., the inside of the base 5)

In various embodiments, the base 5 may include one or more components that sit below the opening. The base 5 may include any device that supports any portion of the lever 3, the lever shaft 6 and/or the spring shaft 7. The lever 3, the lever shaft 6 and/or the spring shaft 7 may be partially supported by the base 5, and partially supported by another component. The base 5 may be integral with the vessel body 1 or the base 5 may be one or more separate components. The base 5 may contain a channel. The channel may align with the opening such that the liquid exits out the bottom of the base 5. The base 5 may be attached to the body with any fastener (e.g., screws).

In various embodiments, the trigger 8 may include any device that provides additional leverage for moving the lever 3. The trigger 8 may include any shape. In various embodiments, the trigger is ergonomically designed to conform to a grip from a hand. The trigger 8 may be pressed by the hand of the user to move the lever 3 and open the valve (e.g., by releasing pressure against the ball 2). The trigger 8 may include an embodiment that is pressed against the top of a drinking glass to release the liquid into the drinking glass. The triggers 8 may be removably attached to the lever 3, such that different triggers 8 may be exchanged.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure.

The scope of the disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one and that reference to an item in the singular may also include the item in the plural. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

The steps recited in any of the method or process descriptions may be executed in any order and are not necessarily limited to the order presented. Furthermore, any reference to singular includes plural embodiments, and any reference to more than one component or step may include a singular embodiment or step. Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

Any reference to attached, fixed, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts or areas but not necessarily to denote the same or different materials. In some cases, reference coordinates may be specific to each figure.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system comprising:
a vessel body configured to retain a liquid,
wherein the vessel body includes an opening;
a valve removably secured within the opening; and
a lever attached to a spring,
wherein the lever is configured to provide a force against the valve to retain the valve within the opening, and
wherein, upon rotation the lever, the force is reduced against the valve and the liquid exits the vessel body.

2. The system of claim 1, further comprising a base below the vessel body.

3. The system of claim 1, further comprising a base below the vessel body, wherein the base includes a channel to allow the liquid to flow.

4. The system of claim 1, further comprising a base below the vessel body, wherein the base includes ribs to hold the valve in position.

5. The system of claim 1, further comprising a base below the vessel body, wherein the base includes a lever shaft that supports the lever.

6. The system of claim 1, further comprising a base below the vessel body, wherein the base includes a spring shaft that supports the spring.

7. The system of claim 1, further comprising a base integral with the vessel body.

8. The system of claim 1, further comprising a trigger attached to the lever.

9. The system of claim 1, further comprising a trigger attached to the lever, wherein the trigger is configured to be pushed by a hand.

10. The system of claim 1, further comprising a trigger attached to the lever, wherein the trigger is configured to be pushed against a drinking glass.

11. The system of claim 1, wherein the vessel body includes graduation marks.

12. The system of claim 1, wherein the vessel body includes steps for major measurements and scribe marks for minor measurements.

13. The system of claim 1, wherein the valve includes a ball.

13. The system of claim 1, wherein the valve comprises at least one of a rotary valve, a cylinder valve or a flap valve.

14. A method comprising:
pouring liquid into a vessel body to a volume;
rotating a trigger that tilts a lever, wherein the lever releases a force against a valve to allow the liquid to flow out of the vessel body.
